(19) United States
(12) Patent Application Publication
(10) Pub. No.: US 2017/0303075 A1
(43) Pub. Date: Oct. 19, 2017

(54) SYSTEM AND METHOD FOR PLAYING LICENSED MUSIC BASED ON BLUETOOTH COMMUNICATION CROSS-REFERENCE TO RELATED APPLICATION

(71) Applicant: BUILDWIN INTERNATIONAL (ZHUHAI) LIMITED, Zhuhai (CN)

(72) Inventors: Martin CHUI, Zhuhai (CN); Mingkun GAO, Zhuhai (CN)

(21) Appl. No.: 15/485,734

(22) Filed: Apr. 12, 2017

(30) Foreign Application Priority Data
Apr. 14, 2016 (CN) 201610237058.7

(51) Int. Cl. H04W 4/00; G06F 21/60; G06F 21/62; H04W 12/08

(52) U.S. Cl. CPC H04W 4/008; H04W 12/08; G06F 21/604; G06F 21/6209

(57) ABSTRACT

A system for playing licensed music based on Bluetooth communication includes a smart device and a Bluetooth playing device. The smart device accesses as online data center via a network. The online data center provides a music resource and a playing authorization service. The Bluetooth playing device is in communication with the smart device via transmission channels. The transmission channels include an audio data transmission channel and a music authorization control Bluetooth channel.

The present disclosure claims priority to Chinese Patent Application No. 201610237058.7, filed with the Chinese Patent Office on Apr. 14, 2016, titled “SYSTEM AND METHOD FOR PLAYING LICENSED MUSIC BASED ON BLUETOOTH COMMUNICATION” the entire contents of which are incorporated herein by reference.

The present disclosure relates to a system and a method for playing licensed music based on Bluetooth communication.

### BACKGROUND

With the popularization of internets and smart mobile devices in daily life, more and more people are enjoying online digital music playing services. Digital music is easy to share, but it can easily cause copyright infringement due to unauthorized dissemination. Thus, network music service providers often use online music playing authorization management means to limit unlicensed music files to be played and downloaded in playing software clients.

In the US patent publication No. U.S. Pat. No. 7,039,615, based on a digital rights management (DRM) software platform proposed by Microsoft Corporation, a content key is generated correspondingly for each song as a unit, and each song cannot be played without a correspondingly matched content key. As encryption and decryption processes of each song are involved, the computation quantity is large, resulting in significant playing delay.

In the Chinese patent No. CN100476842C, based on a copyright management methods, the downloaded songs cannot be played without the playing permission acquired online. However, this technology just limits music downloading devices, and hence lacks convenience. Besides, the method does not support the high-quality and lossless-format music playing.

Therefore, a convenient music permission playing system is desired. With the system, not only the online music playing authorization management and authorization management reliability enhanced, but also high-quality and lossless-format online/offline music playing can be supported.

### SUMMARY

An embodiment of the present disclosure provides a system for playing licensed music based on Bluetooth communication. The system comprises:

a smart device, configured to access a online data center via a network, the online data center providing a music resource and a playing authorization service; and

a Bluetooth playing device configured to be in communication with the smart device via transmission channels, the transmission channels comprising an audio data transmission channel and a music authorization control Bluetooth channel.

Another embodiment of the present disclosure provides a method for playing licensed music based on Bluetooth communication. The method comprises: acquiring a playing authorization identifier in a Bluetooth playing device via a music authorization control Bluetooth channel;

sending a playing list request bound with the playing authorization identifier to an online data center;

after the playing authorization identifier is verified by the online data center, receiving an authorized playing instruction and audio data in an authorized playing list sent by the online data center; and

transmitting the audio data to the Bluetooth playing device via an audio data transmission channel, wherein

a transmission mode adopted by the music authorization control Bluetooth channel comprises a Bluetooth low-energy transmission mode and/or a Bluetooth serial port protocol (SPP) transmission mode.

### BRIEF DESCRIPTION OF THE DRAWINGS

Referring to the drawings, the present disclosure will be described hereinafter, wherein

FIG. 1 shows a schematic structural drawing of a system for playing licensed music based on Bluetooth Communication provided by an embodiment of the present disclosure;

FIG. 2 shows a schematic drawing of a direct networking playing manner of the system provided by an embodiment of the present disclosure;

FIG. 3 shows a schematic drawing of a music playing manner after downloading of the system provided by an embodiment of the present disclosure;

FIG. 4 shows a schematic drawing of a mobile playing manner of the system provided by an embodiment of the present disclosure;

FIG. 5 shows a schematic drawing of a first offline playing method of the system provided by an embodiment of the present disclosure;

FIG. 6 shows a schematic drawing of a second offline playing method of the system provided by an embodiment of the present disclosure; and

FIG. 7 shows a schematic drawing of a third offline playing method of the system provided by an embodiment of the present disclosure.

### DETAILED DESCRIPTION

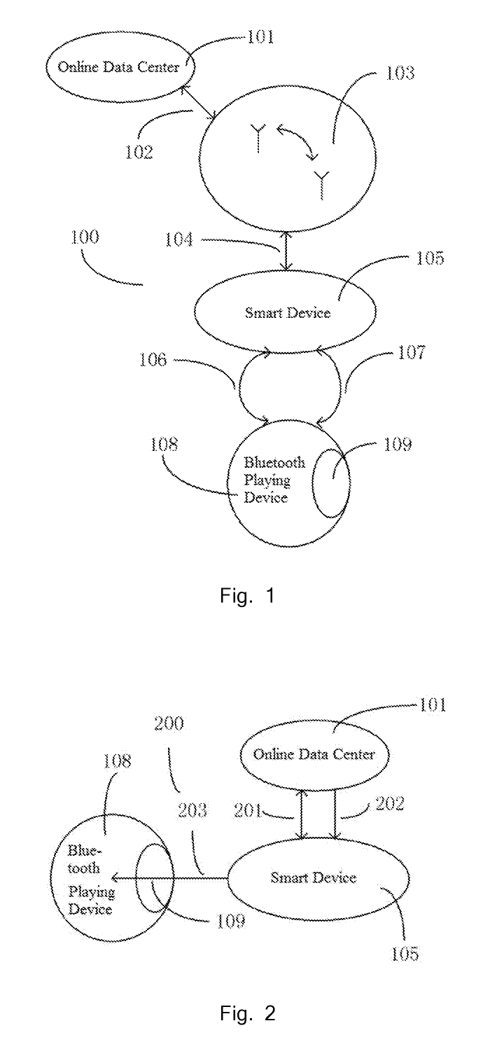

FIG. 1 shows a schematic structural drawing of a system 100 for playing licensed music based on Bluetooth communication provided by an embodiment of the present disclosure. The system 100 comprises an online data center 101, a smart device 105 and a Bluetooth playing device 108, wherein data are transmitted between the online data center 101 and the smart device 105 via a network 103, a transmission channel between the Bluetooth playing device 108 and the smart device 105 comprises an audio data transmission channel 106 and a music authorization control Bluetooth channel 107, and the Bluetooth playing device 108 comprises a memory 109 for storing an audio file and a playing authorization identifier.

In an embodiment, the online data center 101 stores a large number of authorized music resources, communicates with the smart device 105 through an internet or a mobile network 103, and allows the smart device 105 to download music files. The online data center 101 and the smart device 105 may comprise exchange interfaces 102 and 104 respectively, such as a wired network interlace and a WiFi adapter. For example, the smart device 105 may be a smart mobile phone, a tablet computer or the like capable of operating systems such as IOS, Android or Windows, or may also be a digital multimedia player (such as an MP3 player), a personal computer, a game console or other computing devices capable of supporting Bluetooth transmission.

In another embodiment, the audio data transmission channel 106 may adopt a Bluetooth classic (BC) (such as Bluetooth 2.0+EDR) transmission mode or a high-speed Bluetooth (such as Bluetooth 3.0+HS) transmission mode. The transmission channel 106 is higher in data transmission rate, is convenient for transmission of audio data files, and serves as a high-quality lossless-format audio data transmission channel. In a particular embodiment, an audio coding transmission mode adopted by the audio data transmission channel 106 may comprise an Apt-X mode, an SBC mode or an AAC mode. An appropriate audio coding transmission mode may be switched according to the audio playing quality to provide a required listening experience to a user. In another particular embodiment, the Bluetooth playing device 108 may comprise audio playing devices such as a Bluetooth headset and a Bluetooth speaker.

In yet another embodiment, the audio data transmission channel 106 may adopt a wireless local area network transmission mode, a WiFi direct connection transmission mode, a DLNA push transmission mode, an AIRPALY push transmission mode or the like. Thus, after the Bluetooth playing device 108 and/or the smart device 105 verify/(verifies) a playing authorization, the smart device 105 can quickly transmit an audio file to the Bluetooth playing device 108 via a transmission mode such as the wireless local area network transmission mode (e.g., an SMB protocol) or the WiFi direct connection transmission mode, or directly push an audio playing streaming or an audio playing address to the Bluetooth playing device 108 for playing via the DLNA push transmission mode, the AIRPLAY push transmission mode or the like.

In yet another embodiment, the music authorization control Bluetooth channel 107 may adopt a Bluetooth low-energy (BLE) operating mode and/or a Bluetooth serial port protocol (SPP) operating mode. The authorization control Bluetooth channel 107 using the BLE has the characteristic of low energy, and may be directly connected with an IOS/Android device to facilitate system development. Alternatively, the channel 107 may be an SPP control channel.

In yet another embodiment, the smart device 105 and the Bluetooth playing device 108 perform identification and authorized playing by use of a playing authorization identifier according to the system provided by the present disclosure. The playing authorization identifier is associated with a feature code of the Bluetooth playing device 108 and/or a feature code of the smart device 105, so that the online data center 101 is enabled to identity a playing list request uploaded by the corresponding smart device 105 based on the playing authorization identifier, and then authorize and distribute a music resource to the corresponding smart device. The feature code may be a network physical address, an ID or a serial number of the device, or a unique hardware code associated with the device. Preferably, the playing authorization identifier may be encrypted. Thus, whether a music file is authorized to play is verified based on the unique playing authorization identifier only, without generating key information for each audio file, as described in a scheme of the US patent application No. U.S. Pat. No. 7,039,615, thereby simplifying a playing authorization verification process. In addition, the playing authorization identifier based on the hardware device may further ensure the reliability of authorized playing. It should be understood that the system provided by the present disclosure may comprise one or more smart devices 105, and one or more Bluetooth playing devices 108.

According to the present disclosure, any playing operation of the Bluetooth playing device must be authorized by the smart device 105 and the online data center 101. In particular embodiments of the present disclosure, there may be a variety of working manners which are shown in FIGS. 2-7 and described in the various embodiments as follows.

In particular, the smart device may acquire a playing authorization identifier in a Bluetooth playing device via a music authorization control Bluetooth channel, then send a playing list request bound with the playing authorization identifier to an online data center. After the playing authorization identifier is verified by the online data center, the smart device may receive an authorized playing instruction and audio data in an authorized playing list sent by the online data center, and transmit the audio data to the Bluetooth playing device via an audio data transmission channel. In particular embodiments of the present disclosure, a transmission mode adopted by the music authorization control Bluetooth channel comprises a Bluetooth low-energy transmission mode and/or a Bluetooth serial port protocol (SPP) transmission mode.

In particular embodiments of the present disclosure, the smart deceive may acquire a downloading service of an audio data file provided by the online data center to allow the audio data file to be played by the Bluetooth playing device bound with a corresponding authorization identifier in an offline environment. Further, the smart deceive may send the audio data file, via the audio data transmission channel, to a memory in an audio playing module for storage therein so that the audio playing module verifying the authorized playing instruction and the authorized playing list received via the music authorization control Bluetooth channel, and playing the audio data file stored therein.

FIG. 2 shows a direct networking playing manner 200 of the system provided by the present disclosure. An authorized smart device 105 sends a music downloading request 201 to an online data center 101 via an internet; after receiving the request, the online date center 101 returns an authorized playing list corresponding to the music to the smart device 105 via a channel 201, and then transmits a music file to the smart device 105 via a channel 202; after acquiring verification of the authorized playing list, the smart device 105 directly uploads the music file to the Bluetooth playing device 108 via a Bluetooth channel (or the audio data transmission channel) 203; and then the Bluetooth playing device 108 directly plays the music.

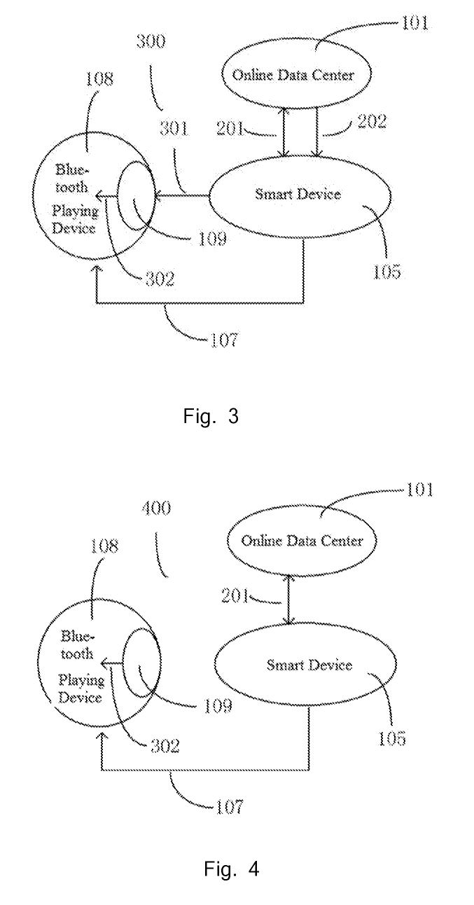

FIG. 3 shows a music playing manner 300 after downloading of the system provided by the present disclosure. After sending a downloading request via the channel 201 and acquiring authorization and a music file from the online data center 101 via the music downloading channel 202, the smart device 105 transmits the music file to a music storage center 109 in the Bluetooth playing device 108 via a BC channel 301. After the Bluetooth playing device 108 receives a complete music file (or one or more pieces of music), when the music is required to be played, at first, the smart device 105 will send authorization information based on the authorized playing list to the Bluetooth playing device 108 via the BLE channel 107. Then, the Bluetooth playing device 108 acquires the music file stored in the music storage center 109 via the channel 301 and plays the music. The playing mannerism advantageously suitable for high-quality and lossless-format music files as well as general music files.

FIG. 4 shows a mobile playing manner 400 of the system provided by the present disclosure. If a user has downloaded the required music to the storage center 109, in a case that there is no a high-speed internet (but only a mobile network), at first, the user can use the smart device 105 to acquire playing authorization via the channel 201 and the online data center 101, and then authorize the Bluetooth playing device 108 to play via the BLE channel or a Bluetooth SPP channel 107. Meanwhile, if the music files allowed offline playing, it can be directly played, without acquiring-authorization via the channel 201. The playing manner has the following advantages: as the playing only needs authorization, there is no need to download the music, and the data traffic is less, so the playing manner is suitable for playing under a mobile network condition; file transmission is not required from the smart device 105 to the playing device 108, while only authorization and the control transmission are required, so the Bluetooth power consumption is less, thereby reducing the power consumption of the playing device 108.

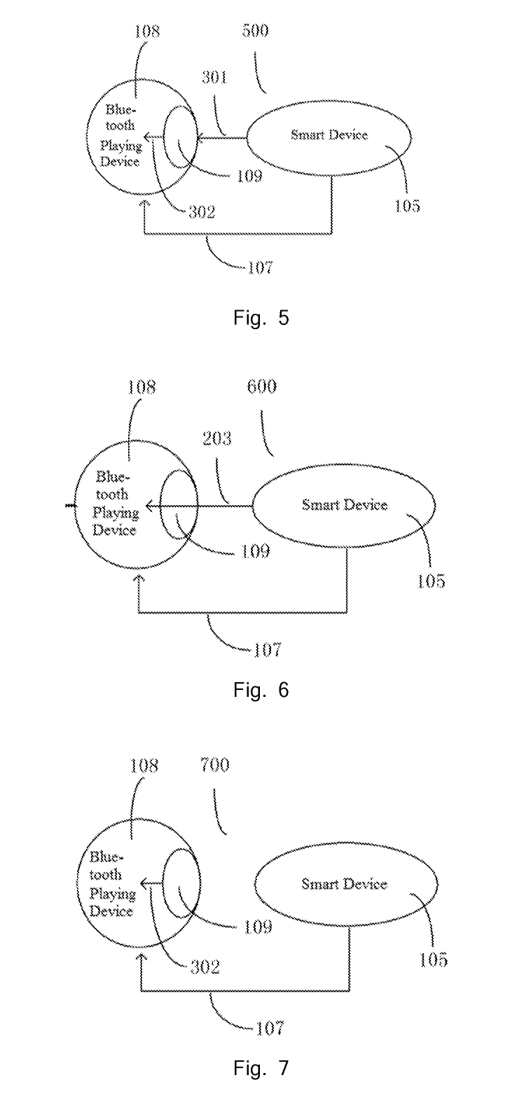

FIG. 5 shows a first offline playing manner 500 of the system provided by the present disclosure. If the online data center 101 allows offline playing of authorized music, the smart device 105 which has downloaded a music file transmits the music file to the music storage center 109 in the Bluetooth playing device 108 via a transmission channel 301. After acquiring authorization from the smart device 105 via the channel 107, the playing device 108 reads and plays the music stored in the music storage center 109 via the channel 301.

FIG. 6 shows a second offline playing manner 600 of the system provided by the present disclosure. If the online data center 101 allows offline playing of authorized music, the smart device 105 which has downloaded a music file enables the playing device 108 to directly play the music via a music transmission channel 203 and an authorization channel 107.

FIG. 7 shows a third offline playing manner 700 of the system provided by the present disclosure. If the online data center 101 allows offline playing of authorized music, alter acquiring playing authorization from the smart device 105 via the channel 107, the playing device 108 reads and plays the music stored in the music storage center 109 via the channel 302.

The above descriptions only cover the preferred embodiments of the present disclosure, and the present disclosure is not limited to these embodiments. Embodiments which may achieve the technical effects of the present disclosure through the same means should be within the protective scope of the present disclosure. The technical schemes and/or the embodiments in the protective scope of the present disclosure may have various modifications and variations.

What is claimed is

1. A system for playing licensed music based on Bluetooth communication, comprising:
a smart device, configured to access a online data center via a network, the online data center, providing a music resource and a playing authorization service; and
a Bluetooth playing device configured to be in communication with the smart device via transmission channels the transmission channels comprising an audio data transmission channel and a music authorization control Bluetooth channel.

2. The system of claim 1, wherein a transmission mode adopted by the music authorization control Bluetooth channel comprises a Bluetooth low-energy transmission mode and/or a Bluetooth serial port protocol (SPP) transmission mode.

3. The system of claim 1, wherein a transmission mode adopted by the audio data transmission channel comprises a classic Bluetooth transmission mode.

4. The system of claim 3, wherein an audio coding mode adopted by the audio data transmission channel comprises one or more of an Apt-X mode, an SBC mode and an AAC mode.

5. The system of claim 3, wherein the transmission mode adopted by the audio data transmission channel comprises a wireless local area network transmission mode, a WiFi direct connection transmission mode, a DLNA push transmission mode or an AIRPLAY push transmission mode.

6. The system of claim 1, wherein the Bluetooth playing device comprises a memory for storing an audio file and a playing authorization identifier.

7. The system of claim 6, wherein the playing authorization identifier is associated with a feature code of the Bluetooth playing device and/or a feature code of the smart device, so that the online data center is enabled to identify a playing list request uploaded by a corresponding smart device based on the playing authorization identifier, and then authorize and distribute a music resource to the corresponding smart device.

8. The system of claim 1, wherein the smart device comprises one of a smart mobile phone, a tablet computer, a digital multimedia player, a personal computer and a game console.

9. A method for playing licensed music based on Bluetooth communication, comprising:
acquiring a playing authorization identifier in a Bluetooth playing device via a music authorization control Bluetooth channel;
sending a playing list request bound with the playing authorization identifier to an online data center;
after the playing authorization identifier is verified by the online data center, receiving an authorized playing instruction and audio data in an authorized playing list sent by the online data center; and
transmitting the audio data to the Bluetooth playing device via an audio data transmission channel, wherein
a transmission mode adopted by the music authorization control Bluetooth channel comprises a Bluetooth low-energy transmission mode and/or a Bluetooth serial port protocol (SPP) transmission mode.

10. The method of claim 9, wherein receiving an authorized playing instruction and audio data in an authorized playing list comprises:
acquiring a downloading service of an audio data file provided by the online data center to allow the audio data file to be played by the Bluetooth playing device bound with a corresponding authorization identifier in an offline environment.

11. The method of claim 9, wherein transmitting the audio data to the Bluetooth playing device comprises:
sending the audio data file, via the audio data transmission channel, to a memory in an audio playing module for storage therein so that the audio playing module verifying the authorized playing instruction and the authorized playing list received via the music authorization control Bluetooth channel, and playing the audio data file stored therein.
